(19) United States
(12) Patent Application Publication
(10) Pub. No.: US 2011/0316352 A1
(43) Pub. Date: Dec. 29, 2011

(54) ELECTRIC POWER SUPPLY CONTROL APPARATUS AND IMAGE FORMING APPARATUS

(75) Inventors: Shinji Kubo, Susono-shi (JP); Fumiaki Mizuno, Suntou-gun (JP)

(73) Assignee: CANON KABUSHIKI KAISHA, Tokyo (JP)

(21) Appl. No.: 13/159,261

(22) Filed: Jun. 13, 2011

(30) Foreign Application Priority Data
Jun. 29, 2010 (JP) 2010-147678

(51) Int. Cl. H01H 47/00

(52) U.S. Cl. 307/125

(57) ABSTRACT

An apparatus including: a device connector to which an external device is to be connected; and a power source configured to supply electric power to the device connector. In response to turn-ON of a switch when the external device is connected, electric power is started to be supplied from the power source to the device connector.

### BACKGROUND OF THE INVENTION

1. Field of the Invention

The present invention relates to an electric power saving technology for a device equipped with an external I/F capable of Plug and Play, such as a USB host connector.

2. Description of the Related Art

An image forming apparatus uses various kinds of DC voltages, including 24 V or 12 V for driving a motor, 5 V for laser irradiation and for USB I/F and Centronics I/F, 3.3 V for CPU and ASIC, and 1.8 V or 1.25 V for ASIC for image processing. Further, in the image forming apparatus, in an electric power saving mode, the output of the DC voltage for an unused function is stopped, or the power feed line is interrupted by turning OFF a switch such as an FET, to thereby reduce electric power consumption. As an example, there is known an image forming apparatus which is configured to activate a power source so that only 3.3 V is output while the outputs of the other DC voltages are stopped, and a necessary DC voltage is output when receiving such a trigger signal that requires resume from the electric power saving mode. However, two kinds of DC voltages are output in an image forming apparatus equipped with an external I/F capable of Plug and Play, such as a USB host connector, which requires a voltage higher than a voltage necessary for a CPU. Therefore, there is a problem that the image forming apparatus is increased in electric power consumption because of electric power consumed by voltage output operations of two DC/DC converters and electric power consumed by a circuit for connecting the two DC/DC converters.

Aimed at solving the above-mentioned problem, for example, Japanese Patent Application Laid-Open No. 2008-134765 discloses the electric power saving technology, which uses a USB device sensor (including a photo interrupter and a movable member) for detecting connection of a USB device to a USB host connector. Specifically, Japanese Patent Application Laid-Open No. 2008-134765 proposes the image forming apparatus, which is configured so that, in the electric power saving mode, an operation of the 5 V power source included in the low voltage power source is stopped, the connection of the USB device to the USB host connector is monitored based on the output of the USB device sensor, and when the connection is detected by the sensor, the 5 V power source is operated.

However, the technology of Japanese Patent Application Laid-Open No. 2008-134765 has the following problem. That is, the photo interrupter is used as the sensor configured to detect the connection of the USB device, and hence an LED of the photo interrupter needs to be always turned ON. In this case, if a necessary LED current of the photo interrupter is 10 mA, electric power of the 3.3 V power source is 33 mW, which means that electric power of 37 mW is consumed in terms of the primary side on the condition that conversion efficiency is 90%.

### SUMMARY OF THE INVENTION

The present invention has been made in view of the above-mentioned circumstances, and has an object to reduce electric power consumption in an image forming apparatus equipped with an external I/F capable of Plug and Play, such as a USB host connector, without lowering usability.

An image forming apparatus according to the present invention includes: a device connector to which an external device is to be connected; a power source configured to supply electric power to the device connector; a control portion configured to control start and stop of the supply of electric power from the power source to the device connector; and a switch which is turned ON in response to connection of the external device to the device connector, wherein the control portion starts the supply of electric power from the power source to the device connector in response to the turn-ON of the switch.

Further features of the present invention will become apparent from the following description of exemplary embodiments with reference to the attached drawings.

### BRIEF DESCRIPTION OF THE DRAWINGS

FIGS. 1A and 1B are a block diagram and an external view illustrating a schematic structure of an image forming apparatus according to a first embodiment of the present invention, respectively.

FIGS. 2A and 2B are views illustrating a structure of a USB device connector portion according to the first embodiment.

FIGS. 3A and 3B are views illustrating the USB device connector portion into which a USB device is inserted, according to the first embodiment.

FIG. 4 is a block diagram illustrating an electrical structure of an apparatus control substrate and an electrical structure of the USB device connector portion according to the first embodiment.

FIG. 5 is a flowchart illustrating a control flow of monitoring USB device connection according to the first embodiment.

FIGS. 6A and 6B are views illustrating a structure of a USB device connector portion according to a second embodiment of the present invention.

FIGS. 7A and 7B are views illustrating the USB device connector portion into which a USB device is inserted, according to the second embodiment.

### DESCRIPTION OF THE EMBODIMENTS

In the following, the structure and the operation of the present invention will be described. Note that, the following embodiments are merely an example, and are not intended to limit the technical scope of the present invention to the embodiments. Hereinafter, referring to the accompanying drawings, a mode for embodying the present invention will be described in detail by way of the embodiments.

First, a first embodiment of the present invention will be described.

Structure of Image Forming Apparatus

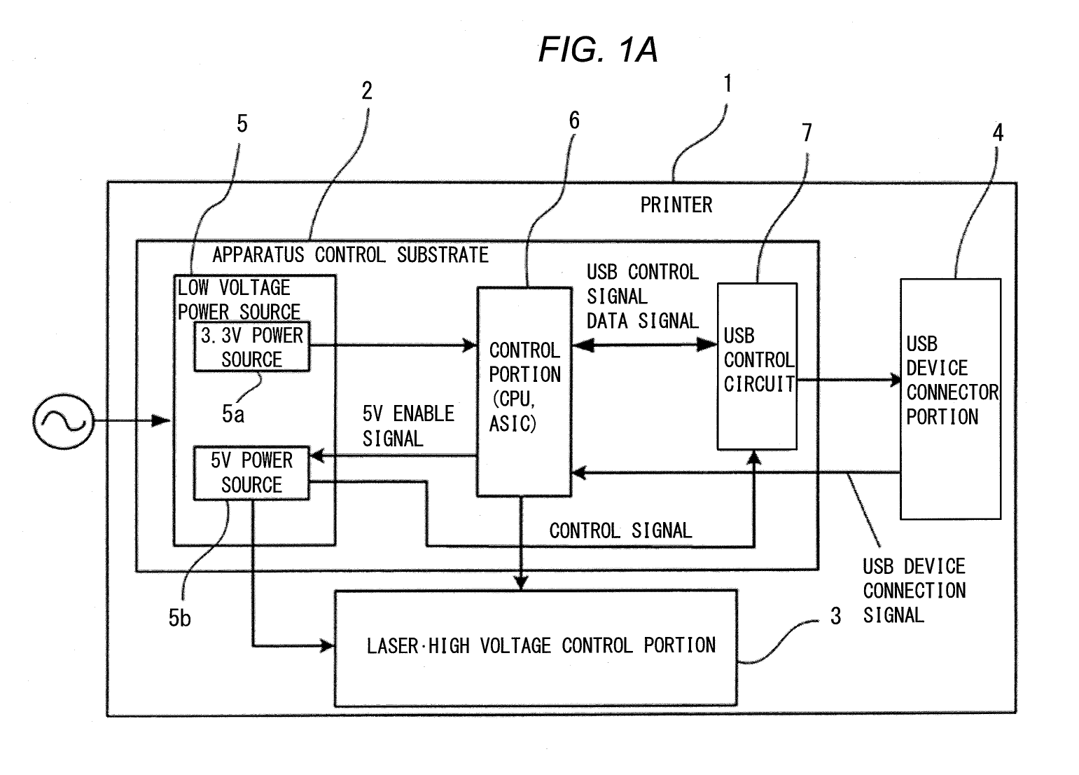

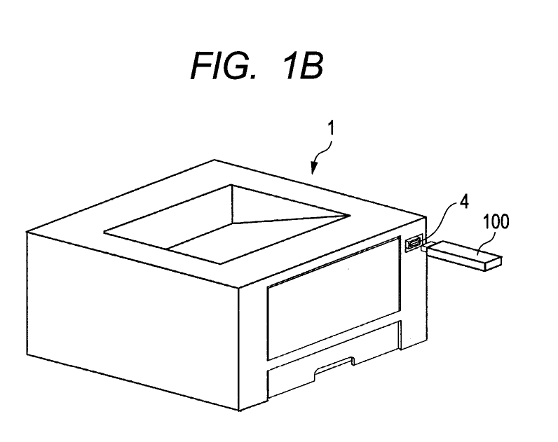

FIG. 1A is a block diagram illustrating a schematic structure of a printer 1, which is an example of an image forming apparatus according to the first embodiment. Referring to FIG. 1A, the printer 1 includes an apparatus control substrate 2, a laser/high voltage control portion 3, and a USB device connector portion 4. The apparatus control substrate 2 is a unit configured to control an operation of the printer 1 and control a power source, and includes a low voltage power source 5, a control portion 6 (CPU, ASIC, etc.), and a USB control circuit 7. The laser/high voltage control portion 3 is a unit which requires a voltage of 5 V for printing. The low voltage power source 5 includes a 3.3 V power source 5a configured to output 3.3 V and a 5 V power source 5b configured to output 5.0 V. The 5 V power source 5b is activated or stopped by a 5 V enable signal supplied from the control portion 6.

FIG. 1B is an external view of the printer 1, illustrating a structure in which the USB device connector portion 4 is provided on the front surface of the printer 1 so that the user can insert a USB device 100 into the USB device connector portion 4. Note that, the USB device connector portion 4 is not limited to be provided on the front surface of the printer 1, and may be provided on the top surface or the side surface as long as the user can access easily.

Structure of USB Device Connector Portion 4

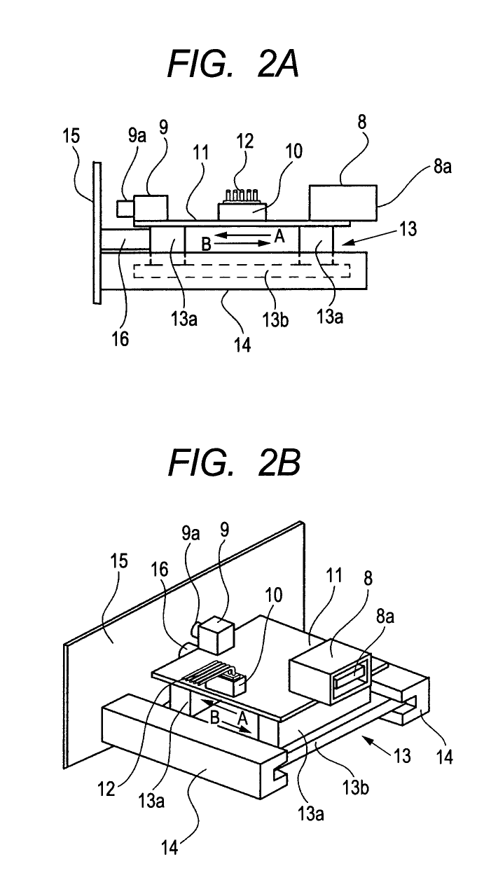

FIGS. 2A and 2B illustrate a mechanical structure of the USB device connector portion 4. FIG. 2A is a side view. FIG. 2B is a perspective view. Referring to FIGS. 2A and 2B, a USB host connector 8, a mechanical switch 9, and a connection cable connector 10 are mounted on a USB substrate 11. The USB host connector 8 is disposed so that a USB device insertion portion 8a thereof faces outwardly from the USB substrate 11. The mechanical switch 9 is mounted on the opposite side of the USB host connector 8 so that a switch movable portion 9a thereof faces outwardly from the USB substrate 11. The connection cable connector is disposed on a side of the USB substrate 11 substantially orthogonal to a side on which the USB host connector 8 is disposed. The USB substrate 11 is connected to the USB control circuit 7 of FIG. 1A via a connection cable 12 which is connected to the connection cable connector 10. Further, a substrate holder 13 is provided under the USB substrate 11. The substrate holder 13 is constituted by two ribs 13a and a plate-shaped slide portion 13b. The USB substrate 11 is fixed onto the two ribs 13a of the substrate holder 13. The slide portion 13b of the substrate holder 13 is sandwiched between U-shaped slide rails 14 disposed on both sides of the slide portion 13b so that the substrate holder 13 is movable in the directions indicated by the arrows A and B. A frame 15 fixed to the printer 1 is provided opposite to the mechanical switch 9. The frame 15 holds the slide rails 14. A compression spring 16 is disposed between the rib 13a of the substrate holder 13 and the frame 15. The compression spring 16 urges the substrate holder 13 in the direction indicated by the arrow B.

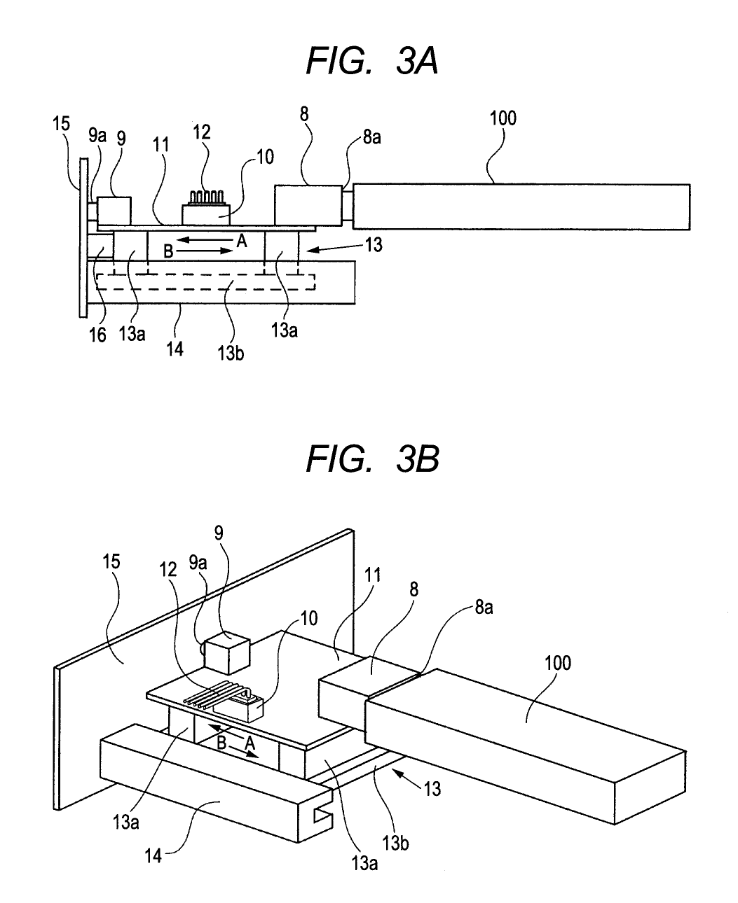

Next, FIGS. 3A and 3B illustrate a mechanical structure of the USB device connector portion 4 into which the USB device 100 is inserted. FIG. 3A is a side view. FIG. 3B is a perspective view. When the user inserts the USB device 100 into the USB host connector 8, the USB substrate 11 and the substrate holder 13 are pushed in the direction indicated by the arrow A (inserting direction) by an inserting force. As a result, the switch movable portion 9a of the mechanical switch 9 abuts against the frame 15, and the USB substrate 11 and the substrate holder are moved in the direction indicated by the arrow A until the mechanical switch 9 is turned ON. In other words, in the operation of inserting the USB device 100 into the USB host connector 8, the USB substrate 11 is moved in the direction indicated by the arrow A so that the mechanical switch 9 is pushed to be turned ON. When the user releases the USB device 100, the substrate holder 13 and the USB substrate 11 are pushed in the direction indicated by the arrow B by the compression spring 16 and returns to the initial position, with the result that the mechanical switch 9 returns to the turned-OFF state. As described above, when the user inserts and retracts the USB device 100 from the USB host connector 8, the mechanical switch 9 can be switched between the turned-ON state and the turned-OFF state.

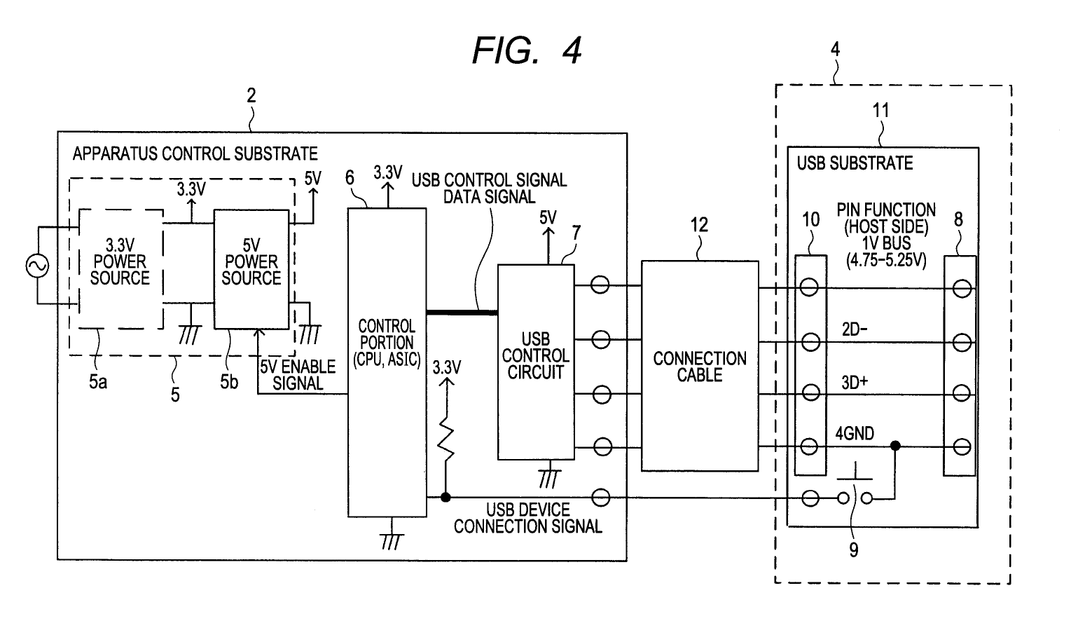

FIG. 4 is a block diagram illustrating an electrical structure of the apparatus control substrate 2 and an electrical structure of the USB device connector portion 4. The apparatus control substrate 2 includes, as illustrated in FIG. 1A as well: the low voltage power source 5 including the 3.3 V power source 5a and the 5 V power source 5b; the control portion 6; and the USB control circuit 7. The USB device connector portion 4 includes the USB substrate 11 on which the USB host connector 8, the mechanical switch 9, and the connection cable connector 10 for making connection to the control portion 6 are mounted. The USB substrate 11 is connected to the USB control circuit 7 via the connection cable 12 which is connected to the connection cable connector 10. The control portion 6 operates at 3.3 V and the USB control circuit 7 operates at 5 V so that communications of a USB control signal and a data signal are performed between the control portion 6 and the USB control circuit 7. Further, during an electric power saving mode in which the 5 V power source 5b is stopped, the control portion 6 monitors a state of the mechanical switch 9 connected to the 3.3 V power source 5a. If the mechanical switch 9 is turned ON, a USB device connection signal is switched from High level to Low level. As a result, the control portion 6 detects the connection of the USB device 100.

Monitoring Control for USB Device Connection

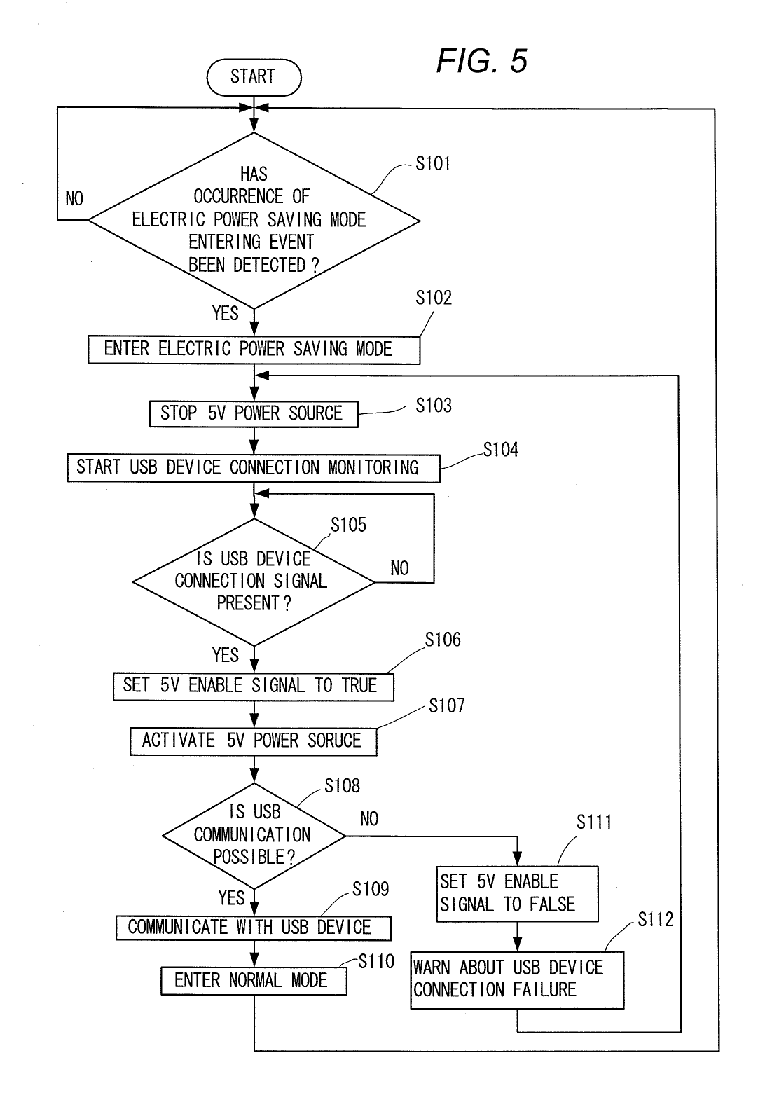

Control of monitoring the USB device connection performed by the control portion 6 will be described with reference to a flowchart of FIG. 5. In normal times, that is, not in the operation in the electric power saving mode, the control portion 6 executes the processing of monitoring occurrence of an electric power saving mode entering event in parallel to other processing (not shown). Note that, the electric power saving mode entering event refers to “a lapse of a predetermined period of time without any reception of print data and a connection of a USB device, or the like, reception of an entering command signal from a host PC, or an access by a user to the switch for causing the mode to enter the electric power saving mode”. When the control portion 6 detects occurrence of the electric power saving mode entering event (Step (hereinafter, referred to as S) 101; Y), the control portion 6 executes the processing of causing the printer 1 to enter the electric power saving mode (S102). Note that, the processing of causing the printer 1 to enter the electric power saving mode is the processing of causing the printer 1 to enter a state in which the output of a voltage to a unit which does not need to work is stopped, such as the processing of stopping generating an unnecessary DC voltage, for example, 24 V.

Next, the control portion 6 stops the 5 V power source 5b (power source for external device I/F) included in the low voltage power source 5 (S103), and starts USB device connection monitoring (S104). In S105, the control portion 6 monitors whether or not a USB device connection signal is present. As described with reference to FIGS. 2A to 4, when the USB device 100 is connected to the USB host connector 8, the mechanical switch 9 is turned ON, and the control portion 6 detects the presence of USB device connection based on the level of the USB device connection signal (YES at S105). The control portion 6 sets the 5 V enable signal to True (S106), and activates the 5 V power source 5b to restart the supply of electric power (S107). The control portion 6 determines whether or not it is possible to communicate with the USB device 100 (S108). Then, when the control portion 6 determines that the USB communication is possible (YES at S108), the control portion 6 performs the USB communication with the USB device (S109), causes the printer 1 to enter the normal mode to execute necessary processing (S110), and returns to the processing of S101. When the control portion 6 has determined that the USB communication is impossible even after a predetermined period of time elapsed since the detection of the presence of USB device connection (NO at S108), the following cases are conceivable. That is, the USB host connector 8 may be pushed by something other than the USB device 100, or the USB host connector 8 may be in a connection failure state because the USB device 100 is not inserted normally. Accordingly, the control portion 6 sets the 5 V enable signal to False (S111), and warns about a USB device connection failure (S112). The control portion 6 warns about the USB device connection failure by, for example, outputting a signal (information) indicative of the connection failure on a display portion (not shown), to thereby notify the user by warning display. Note that, the warning of a connection failure is not limited to the output of a signal on the display portion, and may be performed by a method of outputting a signal to a computer connected to the printer 1. After that, the processing returns to S103, and the control portion 6 stops the 5 V power source 5b again (S103), and starts USB device connection monitoring (S104).

As described above, in the printer 1 according to this embodiment, when occurrence of an electric power saving mode entering event is detected, the 5 V power source 5b is stopped, and then whether or not the USB device 100 has been connected to the USB host connector 8 is monitored based on the change in state of turned-ON/OFF of the mechanical switch 9. In other words, the printer 1 according to this embodiment is configured to eliminate the need to activate the 5 V power source 5b all the time for monitoring the USB device connection. This embodiment provides an effect of reducing electric power consumption during the electric power saving mode (during the stop of 5 V power source) as compared to the conventional image forming apparatus in which the 5 V power source is activated all the time for supplying 5 V to the USB host connector. Meanwhile, the conventional image forming apparatus using a photo interrupter as a sensor configured to detect USB device connection needs an LED of the photo interrupter to be always turned ON for the detection. For that reason, even in the electric power saving mode, electric power for turning ON the LED of the photo interrupter has been necessary. In this embodiment, however, the mechanical switch 9 connected to the 3.3 V power source 5a is used for detecting the USB device connection, and hence no electric power consumption resulting from the always-on photo interrupter is generated.

In this embodiment, the external device I/F connector and the external device are described as the USB device connector portion 4 and the USB device 100, respectively. However, the present invention is not limited thereto, and this embodiment is also applicable to an external device I/F connector capable of Plug and Play and an external device corresponding to the external device I/F connector.

This embodiment can provide a technology with which electric power consumption can be reduced in an image forming apparatus equipped with an external I/F capable of Plug and Play, such as a USB host connector, without lowering usability.

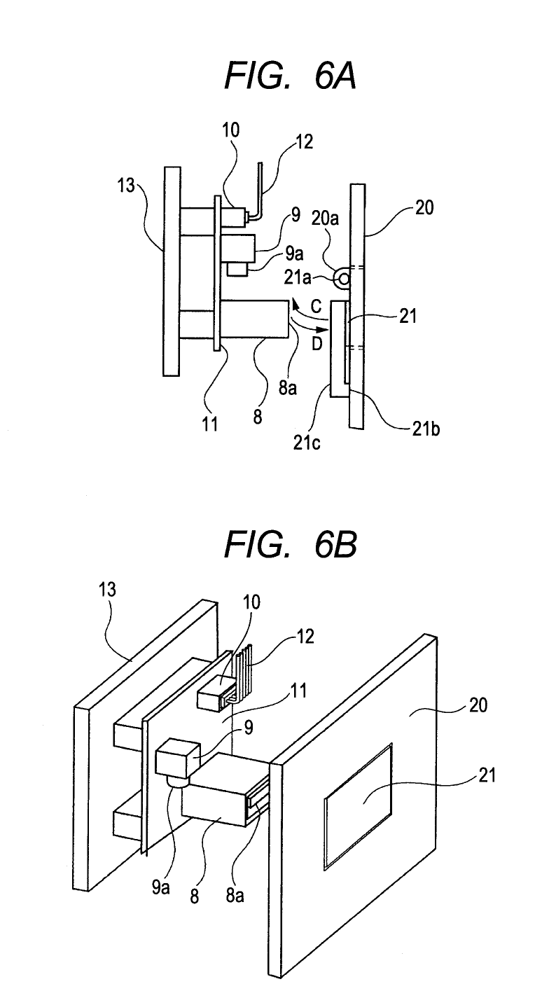

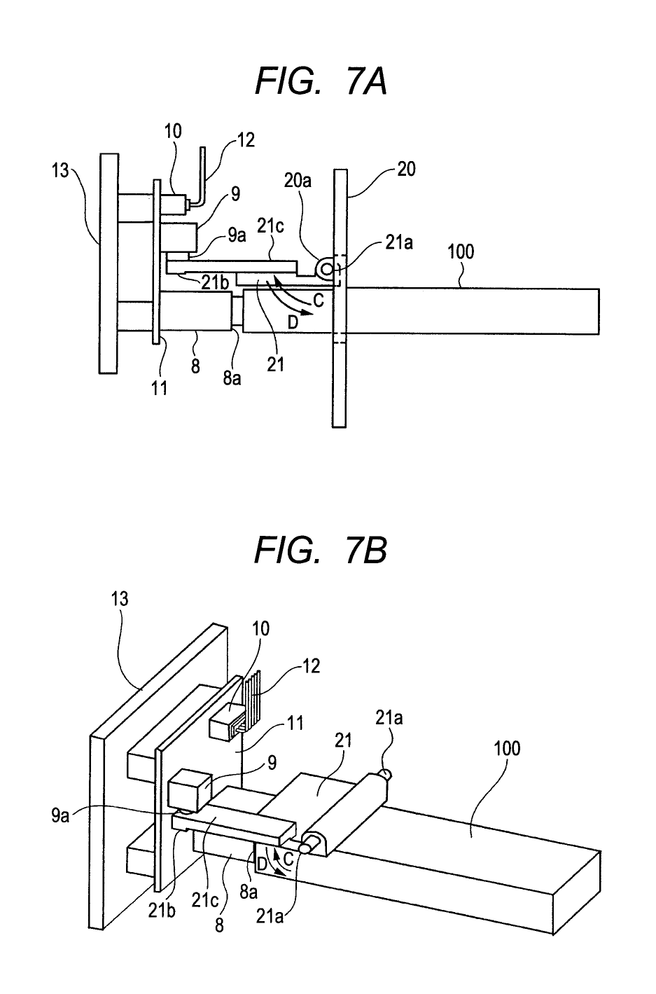

Next, a second embodiment of the present invention will be described with reference to FIGS. 6A, 6B, 7A and 7B. This embodiment relates to a printer 1 in which an exterior cover 20 and a USB cover 21 are provided in the vicinity of the USB host connector 8. The exterior cover 20 and the USB cover 21 are used to protect the internal units of the printer 1. For example, if the USB connector is exposed to the outside, dirt or dust adheres to the connector portion, thus causing a fear of a connection failure. For that reason, the USB connector cover is provided. Note that, the same components as those described in the first embodiment are denoted by the same reference symbols. Further, description of the components and functions as those of the first embodiment is omitted, and only the components characteristic of this embodiment will be described.

FIGS. 6A and 6B illustrate a mechanical structure of the USB device connector portion 4. FIG. 6A is a side view. FIG. 6B is a perspective view. Referring to FIGS. 6A and 6B, the USB host connector 8, the mechanical switch 9, and the connection cable connector 10 are mounted on the USB substrate 11. Referring to FIG. 6A, the USB host connector 8 is disposed so that the USB device insertion portion 8a thereof faces rightward, and the mechanical switch 9 is disposed so that the switch movable portion 9a thereof faces downward. The connection cable connector 10 is disposed on an upper side of the USB substrate 11. The USB substrate 11 is connected to the USB control circuit 7 of FIG. 1A via the connection cable 12 which is connected to the connection cable connector 10. The substrate holder 13 is provided on the left side of the USB substrate 11 so as to fix the USB substrate 11.

Further, on the right side of the USB substrate 11, the exterior cover 20 and the USB cover 21 are provided. The exterior cover 20 is a cover configured to cover the internal units of the printer 1. In FIGS. 6A and 6B, only a part of the exterior cover 20 is illustrated for easier description of the structure of the USB device connection portion. The USB cover 21 has a shaft 21a supported by a bearing 20a of the exterior cover 20 so that the USB cover 21 is rotatable in the directions indicated by the arrows C and D. A surface 21b of the USB cover 21 abuts against the exterior cover 20, so that the rotation thereof is stopped. Note that, the USB cover 21 is not allowed to rotate to the right side with respect to the exterior cover 20.

Next, FIGS. 7A and 7B illustrate a mechanical structure of the USB device connector portion 4 into which the USB device 100 is inserted. FIG. 7A is a side view. FIG. 7B is a perspective view. In FIG. 7B, the exterior cover 20 is omitted for easier description of the shape of the USB cover 21. When the user inserts the USB device 100 into the USB host connector 8, the USB cover 21 is pushed by the USB device 100 to rotate in the direction indicated by the arrow C. In the state in which the USB device 100 is inserted into the USB host connector 8, the USB cover 21 is rotated through about 90° in the direction indicated by the arrow C so that a lever portion 21c of the USB cover 21 pushes the switch movable portion 9a of the mechanical switch 9, with the result that the mechanical switch 9 is turned ON. In other words, when the USB device 100 is inserted into the USB host connector 8, the USB cover 21 is rotated in the direction indicated by the arrow C so that the mechanical switch 9 is pushed to be turned ON. After that, when the user removes the USB device 100, the USB cover 21 is rotated by its own weight in the direction indicated by the arrow D, and the surface 21b of the USB cover 21 abuts against the exterior cover 20, with the result that the USB cover 21 returns to an initial position and the mechanical switch returns to the turned-OFF state.

As described above, when the user performs operation of inserting the USB device 100 into the USB host connector 8, the mechanical switch 9 can be switched between the turned-ON state and the turned-OFF state.

This embodiment can provide a technology with which electric power consumption can be reduced in an image forming apparatus equipped with an external I/F capable of Plug and Play, such as a USB host connector, without lowering usability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-147678, filed Jun. 29, 2010, which is hereby incorporated by reference herein in its entirety.

What is claimed is:

1. An image forming apparatus, comprising:
a device connector to which an external device is to be connected;
a power source configured to supply electric power to the device connector;
a control portion configured to control start and stop of the supply of electric power from the power source to the device connector; and
a switch which is turned ON in response to connection of the external device to the device connector,
wherein the control portion starts the supply of electric power from the power source to the device connector in response to the turn-ON of the switch.

2. An image forming apparatus according to claim 1, wherein the device connector and the switch are mounted on one substrate,
the substrate is movable in a direction in which the external device is inserted, in order to connect the external device to the device connector, and
a movement of the substrate turns ON the switch.

3. An image forming apparatus according to claim 1, further comprising a cover configured to cover the device connector,
wherein the cover is moved when the external device is inserted toward the device connector, and a movement of the cover turns ON the switch.

4. An image forming apparatus according to claim 1, wherein, when the control portion does not detect the connection of the external device even after a predetermined period of time has elapsed since the control portion started the supply of electric power from the power source to the device connector in response to the turn-ON of the switch, the control portion stops the supply of electric power from the power source to the device connector, and outputs a signal for warning about a connection failure of the external device.

5. An image forming apparatus according to claim 1, wherein, when the image forming apparatus enters an electric power saving mode, the control portion performs control of stopping the supply of electric power from the power source to the device connector, and
when the control portion detects that the switch has been turned ON in a state in which the image forming apparatus has entered the electric power saving mode, the control portion starts the supply of electric power from the power source to the device connector.

6. An image forming apparatus according to claim 1, wherein the external device comprises a USB device.

7. An electric power supply control apparatus for controlling supply of electric power to a device connector, the electric power supply control apparatus comprising:
a device connector which is connectable to an external device;
a power source configured to supply electric power to the device connector;
a switch which is turned ON in response to connection of the external device to the device connector; and
a control portion configured to start the supply of electric power from the power source to the device connector in response to the turn-ON of the switch.

8. An electric power supply control apparatus according to claim 7, wherein the device connector and the switch are mounted on one substrate,
the substrate is movable in a direction in which the external device is inserted, in order to connect the external device to the device connector, and
a movement of the substrate turns ON the switch.

9. An electric power supply control apparatus according to claim 7, further comprising a cover configured to cover the device connector,
wherein the cover is moved when the external device is inserted toward the device connector, and a movement of the cover turns ON the switch.

10. An electric power supply control apparatus according to claim 7, wherein, when the control portion does not detect the connection of the external device even after a predetermined period of time has elapsed since the control portion started the supply of electric power from the power source to the device connector in response to the turn-ON of the switch, the control portion stops the supply of electric power from the power source to the device connector, and outputs a signal for warning about a connection failure of the external device.
